(19) United States
(12) Patent Application Publication
(10) Pub. No.: US 2025/0117757 A1
(43) Pub. Date: Apr. 10, 2025

(54) SYSTEM FOR INCREASING QUERY-ANSWERING AGENT ACCURACY

(71) Applicant: Paul Butterworth, Alamo, CA (US)

(72) Inventor: Paul Butterworth, Alamo, CA (US)

(21) Appl. No.: 18/911,074

(22) Filed: Oct. 9, 2024

Related U.S. Application Data
(60) Provisional application No. 63/588,890, filed on Oct. 9, 2023.

(51) Int. Cl. G06Q 10/20

(52) U.S. Cl. CPC G06Q 10/20

(57) ABSTRACT

A system and method comprising receiving a query related to an industrial unit, generating a consultation prompt based on the query; retrieving, using a consultation agent, a response; generating, based on the response, an evaluation prompt; retrieving, using an evaluation agent, a response evaluation; responsive to determining that response evaluation is positive, generating a summarization prompt based on the response; retrieving, using a summarization agent, a response summary, and storing the response summary in a response set used to generate an answer comprising a repair plan, the answer to be transmitted to a scheduling system for scheduling repairs to the industrial unit. The response set further comprises a predetermined minimum number of response summaries from multiple summarization agents and corresponding to responses from multiple consultation agents, the responses evaluated by multiple evaluation agents. The answer to the query is further generated, based on the response summaries, using an aggregation agent.

### CROSS-REFERENCE TO RELATED APPLICATIONS

This application claims the benefit of U.S. Provisional Application No. 63/588,890 filed on Oct. 9, 2023, which is hereby incorporated by reference in its entirety.

### TECHNICAL FIELD

The disclosed subject matter relates generally to the technical field of query-answering systems and, in one specific example, to solutions for increasing the accuracy of a query-answering system.

### BACKGROUND

Automatic query answering and plan formulation systems are important components of many workflows or decision-making pipelines, from industrial workflows to consumer-focused applications. As a result, developers invest time and effort in developing efficient and high-performing query-answering systems that lead to overall gains in efficiency and performance for the overall workflows or pipelines, while reducing friction on behalf of their end users.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a network diagram depicting a system within which various examples described herein may be deployed.

FIG. 2 is a diagrammatic representation of a query-answering system, according to some examples.

FIG. 3 is a flowchart illustrating a method for invoking and using a consultation agent for response generation, according to some examples.

FIG. 4 is a flowchart illustrating a method for evaluating a response using an evaluation agent, according to some examples.

FIG. 5 is a flowchart illustrating a method for generating an aggregated answer using response summaries, according to some examples.

FIG. 6 is a block diagram showing a machine-learning program, according to some examples.

FIG. 7 is a block diagram illustrating an example of a software architecture that may be installed on a machine, according to some examples.

FIG. 8 is a block diagram illustrating components of a machine, according to some examples, able to read instructions from a machine-readable medium and perform any one or more of the methodologies discussed herein.

### DETAILED DESCRIPTION

Automatic query-answering and plan formulation systems are important components of many workflows or decision-making pipelines, from industrial workflows to consumer-focused applications. Modern query-answering agents, using, for example Large Language Models (LLMs) can analyze data, answer queries and/or recommend or complete plans by identifying potential next actions in a given situation. Such query-answering agents can be part of an overall system, such as an industrial system for a specific domain. For example, an industrial system can use such agents to diagnose refrigeration problems based on a set of current measurements of a refrigeration unit, or perform, upon request, an analysis of the operational state of the refrigeration unit. Upon determining that a refrigeration unit is not functional or is not operating at an acceptable level of efficiency, the system can ask the agent for a corrective action plan which is automatically sent to a maintenance scheduling system to dispatch repair personnel.

While modern query-answering agents, for example based on LLMs, have impressive capabilities, they can produce incorrect responses or present an incorrect justification for a correct response. In high-stakes situations or in the case of industrial systems, such limitations lead to the need for a domain expert to evaluate the accuracy of a response and/or a presented justification before incorporating it into a decision-making pipeline. Therefore, a robust query-answering system should address the problem of improving the accuracy and/or safety of an individual query-answering agent. Examples in the disclosure herein refer to a query-answering system that uses multiple sets of query-answering agents as part of example answer formulation strategies that rely on intermediate automatic response validation and/or consensus-based answer formulation. Such strategies increase the overall accuracy of the query-answering system compared to the accuracy of sole query-answering agents, making the query-answering system suitable for inclusion in an autonomous response system. As noted above, the query-answering system can be presented with a query related to an operational state of an industrial unit (e.g., refrigerator unit) and/or potentially a query for a corrective action plan. The query-answering system can return an answer corresponding to an analysis of the operational state, and/or a corrective action plan that is automatically sent to a maintenance scheduling system to dispatch repair personnel. In some examples, Internet-of-Things (IoT) devices on industrial equipment (e.g., mining equipment) collect data (e.g., vibration, temperature, usage patterns, etc.). The query-answering system can receive a query related to an operational state of such a piece of equipment and/or potentially a query for a corrective or maintenance action plant. The query-answering system can return an answer analyzing the operational state, and and/or a corrective or maintenance action plan and/or maintenance schedule. In some examples, the query-answering system can receive queries and/or return answers and/or action or maintenance plans in other industrial workflow scenarios: water treatment plant optimization (e.g., based on data from IoT sensors in water treatment facilities that monitor water quality parameters, chemical levels, flow rates, and so forth), smart grid management (e.g., based on data from IoT devices throughout the power grid that collect information on electricity generation, consumption, or distribution), connected construction sites (e.g., based on data from IoT sensors on construction equipment or materials that tracks usage, location, or environmental conditions), and so forth. In another example, an automatic or semi-automatic medical diagnosis system can present a query-answering system with a collection of patient symptoms and patient health history and request a likely diagnosis. If such a diagnosis is identified and it requires treatment, the query-answering system can be required to provide a treatment plan. The query-answering system can return one or more answers corresponding to a diagnosis and/or a treatment plan. Additional examples of application domains for a query answering system are included below.

Relying on multiple query-answering agents can boost overall accuracy but requires solving additional technical challenges. For example, machine learning (ML) agents such as LLM-based agents can formulate query responses that use similar concepts or domain-level abstractions, but have different surface formats and/or structure. Thus, the query-answering system has to solve the problems of identifying and aggregating common operations or answer components across a set of responses with varying format, structure, and/or vocabulary. Examples in the disclosure herein refer to a query-answering system that uses summarization query-answering agents to summarize and/or normalize validated output of consultation query-answering agents. The query-answering system can use trained aggregation or consensus agents to identify common answer components across a set of normalized and/or summarized responses.

In order to deploy an automated query-answering system as part of an industrial or consumer-facing workflow, a query-answering system must have safe and reliable configuration options. In the case of a query-answering system using multiple individual query-answering agents, some of which can be third-party agents, safe and reliable configuration options should be used at the level of individual query-agents as well. Examples in the disclosure herein refer to a query-answering system that defines a set of configurations, templates and parameters that can be stored, instantiated, and/or tuned as needed.

In some examples, a query-answering system as disclosed herein can be used in a customer support application for answering product-related queries or for troubleshooting issues. Alternatively, the query-answering system can be used to provide financial advice, answer questions about investments, and/or provide risk assessments, for example as part of a chatbot platform for a financial institution or financial advisor. The query-answering system can be used, in a travel planning scenario, to assist with itinerary creation or answering travel-related queries. In some examples, the query-answering system could process data from various sources to evaluate the potential environmental effects of proposed projects or policies. Relatedly, the query-answering system could process demographic data, infrastructure information and/or environmental factors to assist in answering questions relevant to city development and zoning decisions. The query-answering system could answer questions about efficient energy distribution strategies using aggregated information from power plants, agents analyzing consumptions patterns, and so forth.

Overall, examples in the disclosure herein refer to a query-answering system that enhances the accuracy and reliability of automated responses in a variety of domains. The query-answering system relies on multiple query-answering agents to generate, assess, and/or normalize responses. By aggregating responses from multiple agents, the query-answering system increases overall response accuracy compared to individual agents. By incorporating intermediate automatic response validation and/or a configurable architecture, the query-answering system enables improved accuracy, consistency, and adaptability, rendering it suitable for integration into various workflows and/or decision-making pipelines.

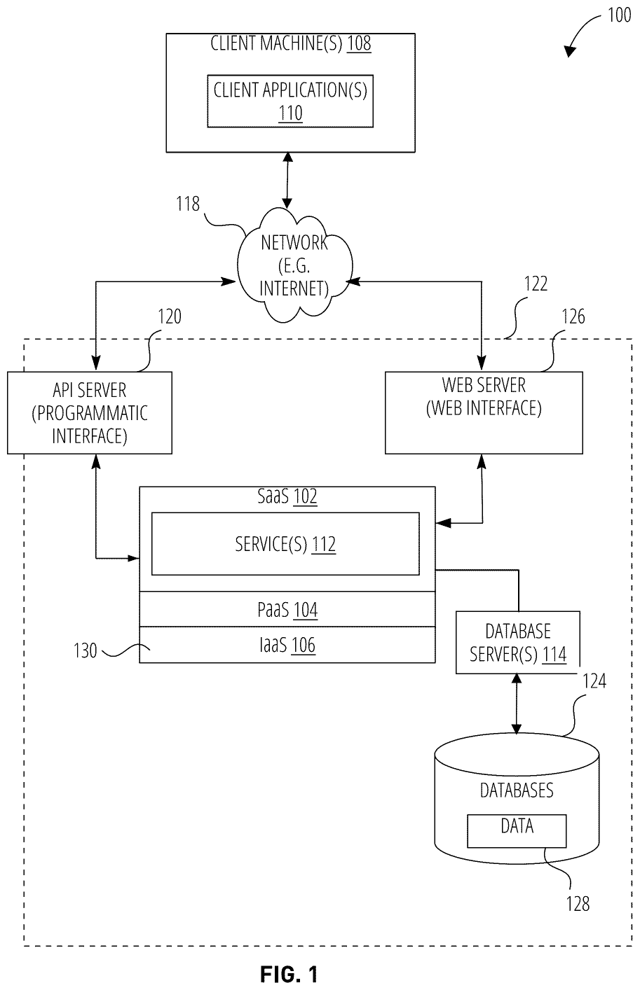

FIG. 1 is a network diagram depicting a system 100 within which various examples described herein may be deployed. A networked system 122 in the example form of a cloud computing service, such as Microsoft Azure or other cloud service, provides server-side functionality, via a network 118 (e.g., the Internet or Wide Area Network (WAN)) to one or more endpoints (e.g., client machine(s) 108). FIG. 1 illustrates client application(s) 110 on the client machine(s) 108. Examples of client application(s) 110 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, contact center applications, digital content creation applications (e.g., game development applications) or game applications. Each of the client application(s) 110 may include a software application module (e.g., a plug-in, add-in, or macro) that adds a specific service or feature to the application.

An API server 120 and a web server 126 are coupled to, and provide programmatic and web interfaces respectively to, one or more software services, which may be hosted on a software-as-a-service (SaaS) layer or platform 102. The SaaS platform may be part of a service-oriented architecture, being stacked upon a platform-as-a-service (PaaS) layer 104 which, may be, in turn, stacked upon an infrastructure-as-a-service (IaaS) layer 106 (e.g., in accordance with standards defined by the National Institute of Standards and Technology (NIST)).

While the applications (e.g., service(s)) 112 are shown in FIG. 1 to form part of the networked system 122, in some examples, the applications 112 may form part of a service that is separate and distinct from the networked system 122.

Further, while the system 100 shown in FIG. 1 employs a cloud-based architecture, various examples are, of course, not limited to such an architecture, and could equally well find application in a client-server, distributed, or peer-to-peer system, for example. The various server services or applications 112 could also be implemented as standalone software programs. Additionally, although FIG. 1 depicts machine(s) 108 as being coupled to a single networked system 122, it will be readily apparent to one skilled in the art that client machine(s) 108, as well as client application(s) 110 (such as game applications), may be coupled to multiple networked systems, such as payment applications associated with multiple payment processors or acquiring banks (e.g., PayPal, Visa, MasterCard, and American Express).

Web applications executing on the client machine(s) 108 may access the various applications 112 via the web interface supported by the web server 126. Similarly, native applications executing on the client machine(s) 108 may access the various services and functions provided by the applications 112 via the programmatic interface provided by the API server 120. For example, the third-party applications may, utilizing information retrieved from the networked system 122, support one or more features or functions on a website hosted by the third party. The third-party website may, for example, provide one or more promotional, marketplace or payment functions that are integrated into or supported by relevant applications of the networked system 122.

The server applications may be hosted on dedicated or shared server machines (not shown) that are communicatively coupled to enable communications between server machines. The server applications 112 themselves are communicatively coupled (e.g., via appropriate interfaces) to each other and to various data sources, so as to allow information to be passed between the server applications 112 and so as to allow the server applications 112 to share and access common data. The server applications 112 may furthermore access one or more databases 124 via the database server(s) 114. In some examples, various data items are stored in the databases 124, such as the system's data items 128. In some examples, the system's data items may be any of the data items described herein.

Navigation of the networked system 122 may be facilitated by one or more navigation applications. For example, a search application (as an example of a navigation application) may enable keyword searches of data items included in the databases 124 associated with the networked system 122. A client application may allow users to access the system's data items 128 (e.g., via one or more client applications). Various other navigation applications may be provided to supplement the search and browsing applications.

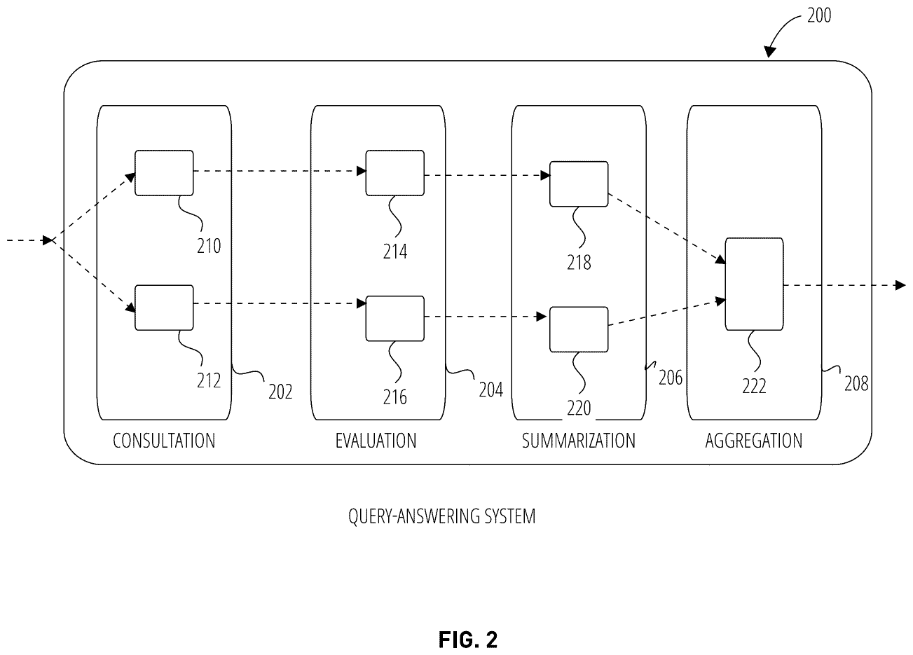

FIG. 2 is a diagrammatic representation of a query-answering system 200, according to some examples. The query-answering system 200 includes one or more of a consultation component 202, an evaluation component 204, a summarization component 206, and an aggregation component 208, among other components.

The query-answering system 200 receives an input that describes a query or problem to be solved, together with information or evidence available for formulating a response. The input can be provided as a prompt (e.g., a structured prompt). In some examples, a structured prompt is generated based on the input. The input and/or structured prompt can ask for a diagnosis or a diagnostic approach, a process for redressing a problem or for taking an action (e.g., a plan formulation), a next action recommendation, and so forth.

Given a structured prompt, the query-answering system 200 provides the information in the prompt to one or more consultation agents that are part of a consultation component 202 (e.g., consultation query-answering agents such as agents 210 or 212). In some examples, consultation agents are query-answering agents that use Large Language Models (LLMs). Given a consultation agent, the query-answering system 200 generates a specialized or customized input, such as a prompt, adapted to the specific agent. For example, for LLM agents, specialized or customized prompts are useful because each trained LLM agent may respond to inputs or prompts differently based on its training and configuration. For example, query-answering agents may use different foundation models (e.g., a model from the Gemini family, GPT family, Llama family, and so forth), and/or different fine-tuning strategies. In such cases and others, different prompt strategies may work best with each such trained and/or fine-tuned model. By using a prompt customization approach, each LLM agent can be provided with a high-quality, specialized prompt that elicits a high-quality response from the LLM agent.

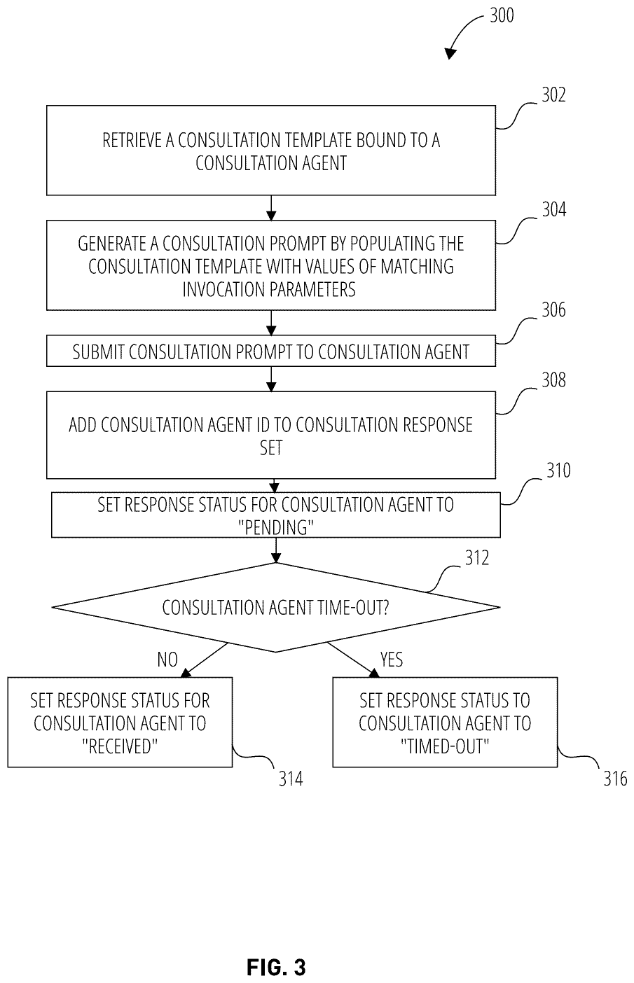

The query-answering system 200 submits customized consultation prompts derived from the input prompt to the consultation agents (see FIG. 3 for more details). The consultation prompts can be submitted in parallel, or using a scheduling scheme that takes into account, for example, an estimate of how fast each consultation agent is likely to respond. In some examples, the query-answering system 200 waits, for a predetermined maximum time period T₁, for each agent to provide a response. If N consultation agents have responded (where N is a constant, such as N>=3, or a pre-determined percentage P of the number of agents in the consultation component 202), the query-answering system 200 continues to the next step in a response evaluation and summarization workflow. If the minimum number of agents providing a response has not been met during a predetermined time period T₂ (T₂>=T₁), the query-answering system 200 ends the workflow and returns a custom response to an end user, to an API, or to a requesting system or software component. In some examples, the custom response can be retrieved by the query-answering system 200 from a configuration file. The configuration file can optionally include one or more custom responses, together with one or more triggers and/or conditions for the use of each custom response.

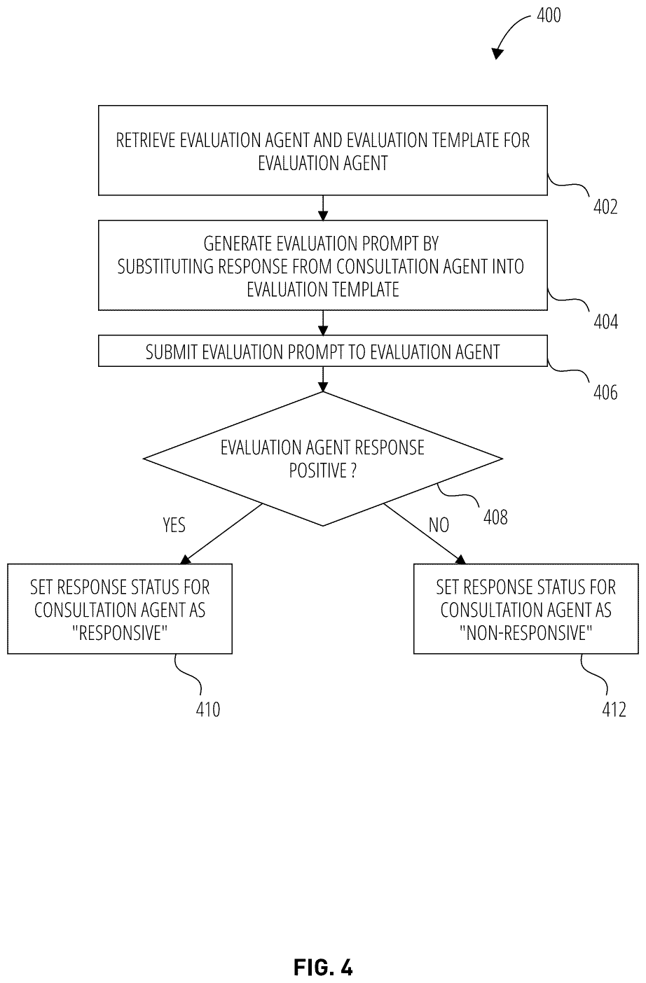

Given a response provided by a consultation agent in the consultation component 202, the response is transmitted to an evaluation agent in the evaluation component 204 (e.g., an evaluation query-answering agent such as 214, 216) (see FIG. 4 for more details). In some examples, evaluation agents are query-answering agents that use LLMs. Each consultation agent in the consultation component 202 is paired with, or bound to, a corresponding evaluation agent in the evaluation component 204. While an agent can appear as a consultation agent and, separately, as an evaluation agent, the first instance of the agent cannot be paired with, or bound to, the second instance of the agent. In other words, a consultation agent cannot use itself as an evaluation agent.

The evaluation agent (e.g., a LLM agent) is presented with a request, for example in the form of an evaluation prompt, asking if the response directly addresses the query in the consultation prompt sent to the corresponding consultation agent. If the evaluation agent indicates that the response is not relevant or responsive to the query, the response is ignored going forward. If the evaluation agent indicates the response is relevant or responsive, the response is transmitted to a summarization agent (e.g., 218, 220) that is part of the summarization component 206. In some examples, summarization agents are query-answering agents that use LLMs. A summarization agent receives, as part of an evaluation prompt, the response together with a request for a summary of the response. In some examples, generating a response summary includes using a templated and/or normalized output structure. In some examples, the summarization agent can reframe or rephrase part or all of the content in the response while generating the response summary using a vocabulary automatically aligned with, or extracted from, one or more domain-specific thesauri, domain-specific corpora, and/or other domain-specific artifacts provided as input. Each original consultation agent is paired with, or bound to, a summarization agent. An agent can appear both in the consultation component 202 and the summarization component 206, but cannot be bound to itself (e.g., an agent cannot summarize its own response). The response and/or the response summary are added to a response set (e.g., a consultation response set).

The above operations are performed for some or all the responses provided by consultation agents in the consultation component 202. After summarization of available responses by summarization component 206, the query-answering system 200 checks whether the response set meets a predefined consultation response quorum corresponding to the presence of at least M responses with associated summaries (e.g., where M is a constant, M>=3, etc.). If the consultation response quorum is met, the query-answering system 200 continues the workflow. If the response set does not contain enough responses, the evaluation workflow is terminated and a custom response (e.g., “not responsive”) is returned by the query-answering system 200.

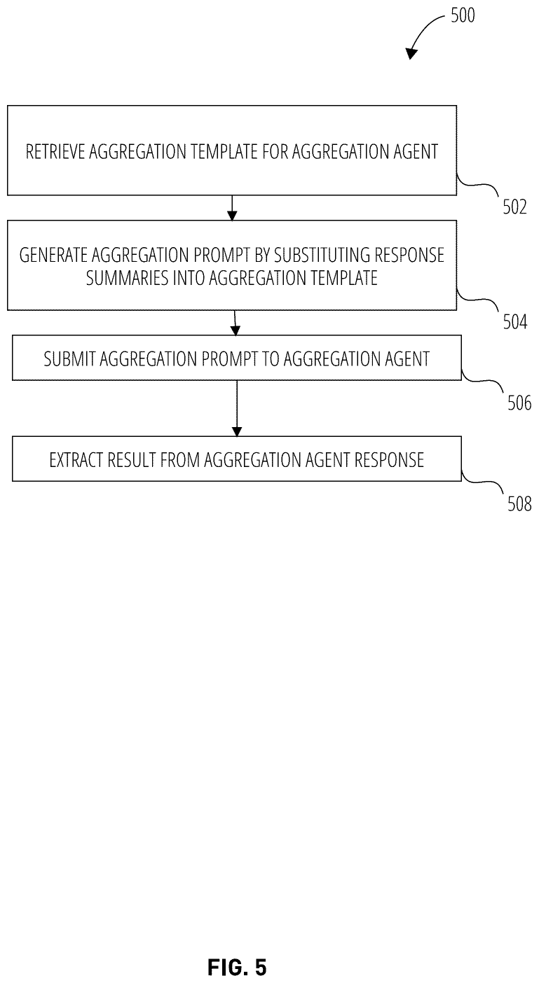

Given a set of responses and/or response summaries, the query-answering system 200 transmits the set of responses and/or summaries to an aggregation agent (e.g., 222) that is part of an aggregation component 208 (see FIG. 5 for more details). In some examples, an aggregation agent is a query-answering agent that uses LLMs. The transmission includes an aggregation prompt asking the agent to extract and aggregate the elements of a solution or answer that are included in a predetermined number or proportion of the individual responses (e.g., many of the individual responses, a majority of the individual responses, etc.). In some examples, the aggregation component 208 can be a consensus component, returning, for example, only elements that appear in all the individual responses. The aggregated answer is returned by the query-answering system 200 as the overall query-answering system answer to the initial input or query.

### Example Setup: Named Consultations

An example query-answering system 200 first establishes the configuration of a set of one or more named consultations. A named consultation defines an input (e.g., in the form of a prompt) for which the system desires a response. The consultations are named because they are likely to be invoked multiple times during the course of system execution. A named consultation configuration includes the following properties:

1. A description of a consultation component or consultation set (e.g., 202), consisting of a configuration for each of a set of consultation agents (e.g., a LLM agent). A configuration of a consultation agent includes the following:
a. A reference or identity of the consultation agent
b. A consultation agent invocation descriptor
c. A consultation agent prompt template
d. A reference to or identity of an evaluation agent that is part of an evaluation component (e.g., evaluation component 204).
e. An evaluation agent prompt template
f. A reference to or identity of a summarization agent that is part of a summarization component (such as summarization component 206).
g. A summarization agent prompt template.

2. A description of an evaluation component or evaluation set (e.g., 204) that includes a set of evaluation agents (e.g., LLM agents). A configuration of an evaluation agent includes an evaluation agent invocation descriptor.

3. A description of a summarization component or set (e.g., 206) that includes a set of summarization agents (e.g., LLM agents). A configuration of a summarization agent includes a summarization agent invocation descriptor.

4. A prompt template defined for each invocation of a consultation agent, evaluation agent, or summarization agent. At runtime, the prompt template is populated with specific parameters required to characterize the problem instance being evaluated. On each invocation of an agent, the relevant parameters are substituted into the prompt template to produce a prompt and each resulting prompt is presented to its corresponding agent. In some examples, prompt templates include:
a. A consultation template, defined for each consultation agent.
b. An evaluation template defined for each binding between an evaluation agent and a consultation agent.
c. A summarization template defined for each binding between an evaluation agent and a summarization agent.

5. Invocation parameters that identify the information that must be supplied by the user or software component invoking the query-answering system 200 to successfully invoke a named consultation. Invocation parameters include parameters required by one or more of the consultation component 202, the evaluation component 204, the summarization component 206, or the aggregation component 208. Each invocation parameter is named and substituted into the prompt templates that reference the named parameter.

6. A description of the aggregation component 208, that includes at least one aggregation agent (e.g., an LLM agent). An aggregation agent is invoked to determine a predominant or consensus answer to the original prompt to the named consultation. An aggregation template (or consensus template) is defined for the aggregation agent. Summarized responses are substituted into the aggregation template before a resulting instantiated aggregation prompt is given as input to the aggregation agent.

Given the above definition of a named consultation, when an instance of a named consultation is invoked with a set of parameter values, a data structure is created to hold the evaluation state for the named consultation instance. A named consultation instance is associated with the following properties:

1. A named consultation instance identifier, which uniquely identifies an invocation of a named consultation.

2. A consultation response set, which contains the response produced by each consultation agent that is part of the consultation component 202. An entry in the consultation response set includes:
a. An identity of the corresponding consultation agent.
b. A response status, which takes one of at least the following values:
“pending”: indicating a current wait for a response from the consultation agent
“received”: indicating a response from the consultation agent has arrived
“responsive”: indicating that a response has arrived from the consultation agent and that an evaluation agent has determined the response to be responsive to the prompt.
“non-responsive”: indicating that a response has arrived and the evaluation agent has determined the response is not responsive to the prompt.
“timedOut”: indicating that the response did not arrive in a timely manner, characterized by a prespecified time period.
c. A response: the text of the response from the consultation agent.
d. A summary: the text produced by the summarization agent.

3. An aggregated answer (or a consensus answer) corresponding to the response produced by the aggregation agent (or consensus agent) based on the response summaries in the consultation response set.

FIG. 3 is a flowchart illustrating a method 300, as implemented by the query-answering system 200, according to some examples. The query-answering system 200 uses one or more consultation agents in the consultation component 202 in order to generate a response to a received input. Method 300 illustrates an example of how a consultation agent in the consultation component 202 is invoked and used for response generation.

At operation 302, the query-answering system 200 retrieves a consultation prompt template bound to a consultation agent. A fully-realized prompt (e.g., a consultation prompt) is generated, at operation 304, by populating the consultation prompt template with values from invocation parameters, based on matching names of parameters in the invocation parameters with the names of parameters in the consultation template. At operation 306, the query-answering system 200 submits the realized prompt (e.g., asynchronously), to the consultation agent. The query-answering system 200 adds an entry corresponding to the consultation agent to a consultation response set at operation 308, where the entry includes an ID for the consultation agent. The corresponding entry can also include a response status, which is set to “pending” at operation 310.

At operation 312, the query-answering system 200 checks whether the consultation agent has timed out, or has returned a response within a predetermined period of time. If a response was returned in a timely manner, the corresponding consultation agent entry has the response status set to “received” (at operation 314), and the workflow of the query-answering system 200 continues as detailed in FIG. 4. Otherwise, the response status is marked as “timed out” (at operation 316).

FIG. 4 is a flowchart illustrating a method 400, as implemented by the query-answering system 200, according to some examples. Given a response generated by a consultation agent, the query-answering system 200 uses an evaluation agent in the evaluation component 204 to evaluate whether the response is relevant or responsive to the original query or input, as detailed below.

Given a response generated by a consultation agent, the query-answering system 200 retrieves, at operation 402, the information of an evaluation agent in the evaluation component 204 which is associated, as per a named consultation, with the consultation agent. The query-answering system 200 additionally retrieves at operation 402 an evaluation prompt template for evaluation agent. At operation 404, the query-answering system 200 generates a fully-realized or instantiated evaluation prompt by substituting the response from the consultation agent into the evaluation template. At operation 406, the query-answering system 200 submits the evaluation prompt to the evaluation agent. At operation 408, the query-answering system 200 assesses a returned response from the evaluation agent to determine if there was a positive determination (corresponding to the consultation agent response being responsive or relevant to the original input to the system) or a negative determination (corresponding to a consultation agent response being non-response or irrelevant to the original input).

If the determination is positive, the response status for the consultation agent in the consultation response set entry is set to “responsive” (at operation 410), and a summarization agent in the summarization component 206 (not shown) is asked to summarize the response, as detailed in FIG. 2. The response from the summarization agent is stored as part of a “summary” property in the consultation response set entry associated with the consultation agent.

If the determination is negative, the response status is set to “non-responsive” (at operation 412). In some examples, the consultation prompt, the evaluation prompt and/or the consultation agent response and/or the evaluation agent response are logged for further evaluation.

FIG. 5 is a flowchart illustrating a method 500, as implemented by the query-answering system 200, according to some examples. Given a set of response summaries obtained from summarization agents in the summarization component 206, the query-answering system 200 retrieves an aggregation prompt template from a named consultation (at operation 502). The query-answering system 200 generates a fully-realized or instantiated aggregation prompt by substituting the response summaries into the aggregation prompt template, at operation 504. The aggregation prompt is submitted to an aggregation agent in the aggregation component 208 (at operation 506). Given a response produced by the aggregation agent, the query-answering system 200 extracts a result from the response and returns or transmits the result to a user, an API, a calling software component, and so forth.

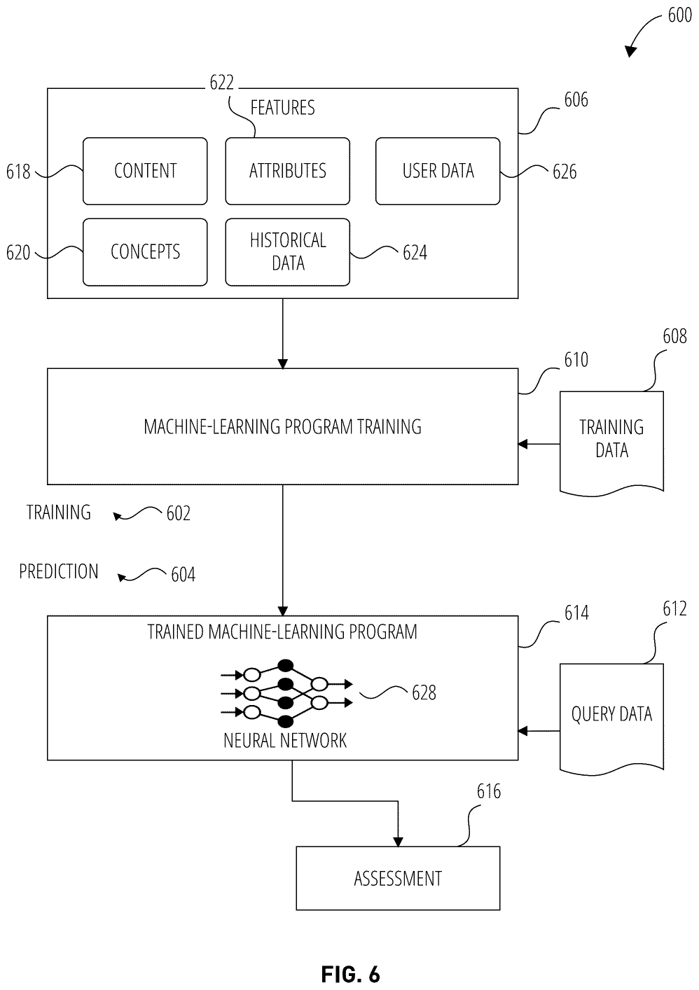

FIG. 6 is a block diagram showing a machine-learning program 600 according to some examples. The machine-learning programs 600, also referred to as machine-learning algorithms or tools, are used to train machine learning models, which can be used by the agents described at least in FIG. 2 of the disclosure herein.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 608 in order to make data-driven predictions or decisions expressed as outputs or assessments (e.g., assessment 616). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g. stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 600 supports two types of phases, namely a training phase 602 and prediction phase 604. In a training phase 602, supervised learning, unsupervised or reinforcement learning may be used. For example, the machine-learning program 600 (1) receives features 606 (e.g., as structured or labeled data in supervised learning) and/or (2) identifies features 606 (e.g., unstructured or unlabeled data for unsupervised learning) in training data 608. In a prediction phase 604, the machine-learning program 600 uses the features 606 for analyzing input or (query) data 612 to generate outcomes or predictions, as examples of an assessment 616.

In the training phase 602, feature engineering is used to identify features 606 and may include identifying informative, discriminating, and independent features for the effective operation of the machine-learning program 600 in pattern recognition, classification, and regression. In some examples, the training data 608 includes labeled data, which is known data for pre-identified features 606 and one or more outcomes. Each of the features 606 may be a variable or attribute, such as individual measurable property of a process, article, system, or phenomenon represented by a data set (e.g., the training data 608). Features 606 may also be of different types, such as numeric features, strings, and graphs, and may include one or more of content 618, concepts 620, attributes 622, historical data 624 and/or user data 626, merely for example.

In training phases 602, the machine-learning program 600 uses the training data 608 to find correlations among the features 606 that affect a predicted outcome or assessment 616.

With the training data 608 and the identified features 606, the machine-learning program 600 is trained during the training phase 602 at machine-learning program training 610. The machine-learning program 600 appraises values of the features 606 as they correlate to the training data 608. The result of the training is the trained machine-learning program 614 (e.g., a trained or learned model).

Further, the training phases 602 may involve machine learning (such as deep learning), in which the training data 608 is structured (e.g., labeled during preprocessing operations), and the trained machine-learning program 614 implements a relatively simple neural network 628 (or one of other machine learning models, as described herein) capable of performing, for example, classification and clustering operations. In other examples, the training phase 602 may involve training data 608 which is unstructured, and the trained machine-learning program 614 implements a deep neural network 628 that is able to perform both feature extraction and classification/clustering operations.

A neural network 628 generated or trained during the training phase 602 and implemented within the trained machine-learning program 614, may include a hierarchical (e.g., layered) organization of neurons. For example, neurons (or nodes) may be arranged hierarchically into a number of layers, including an input layer, an output layer, and multiple hidden layers. The layers within the neural network 628 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 628 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

During prediction phases 604 the trained machine-learning program 614 is used to perform an assessment. Query data 612 is provided as an input to the trained machine-learning program 600, and the trained machine-learning program 614 generates the assessment 616 as output, responsive to receipt of the query data 612.

In some examples, the trained machine-learning program 614 may be a generative artificial intelligence (AI) model. Generative AI is a term that may refer to any type of artificial intelligence that can create new content from training data 608. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data include predictions, translations, summaries or media content.

In some generative AI examples, the trained machine-learning program 614 can be a Large Language Model (LLM). LLMs can perform tasks such as recognizing, translating, predicting, or generating text (or other content), and can be used for text classification, question answering, document summarization, text generation, as well as plan generation, code generation, prediction problems (e.g., predicting protein structures), and so forth. Examples of LLMs include GPT-3.5, GPT-4, Bard, Cohere, PaLM, Falcon, Claude, Llama, Orca, Phi-1, Jurassic and more.

A trained neural network model (e.g., a trained machine-learning program 614 using a neural network 628) may be stored in a computational graph format, according to some examples. An example computational graph format is the Open Neural Network Exchange (ONNX) file format, an open, flexible standard for storing models which allows reusing models across deep learning platforms/tools, and deploying models in the cloud (e.g., via ONNX runtime).

In some examples, one or more artificial intelligence agents, such as one or more machine-learned algorithms or models and/or a neural network of one or more machine-learned algorithms or models may be trained iteratively (e.g., in a plurality of stages) using a plurality of sets of input data. For example, a first set of input data may be used to train one or more of the artificial agents. Then, the first set of input data may be transformed into a second set of input data for retraining the artificial intelligence agents. The continuously updated and retrained artificial intelligence agents may then be applied to subsequent novel input data to generate one or more of the outputs described herein.

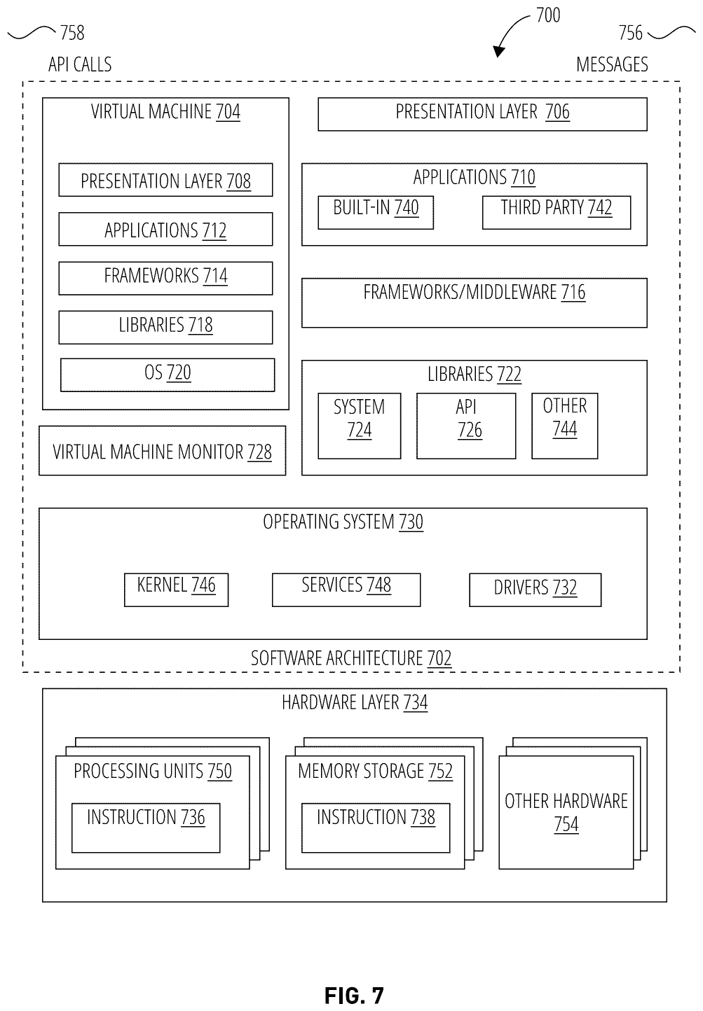

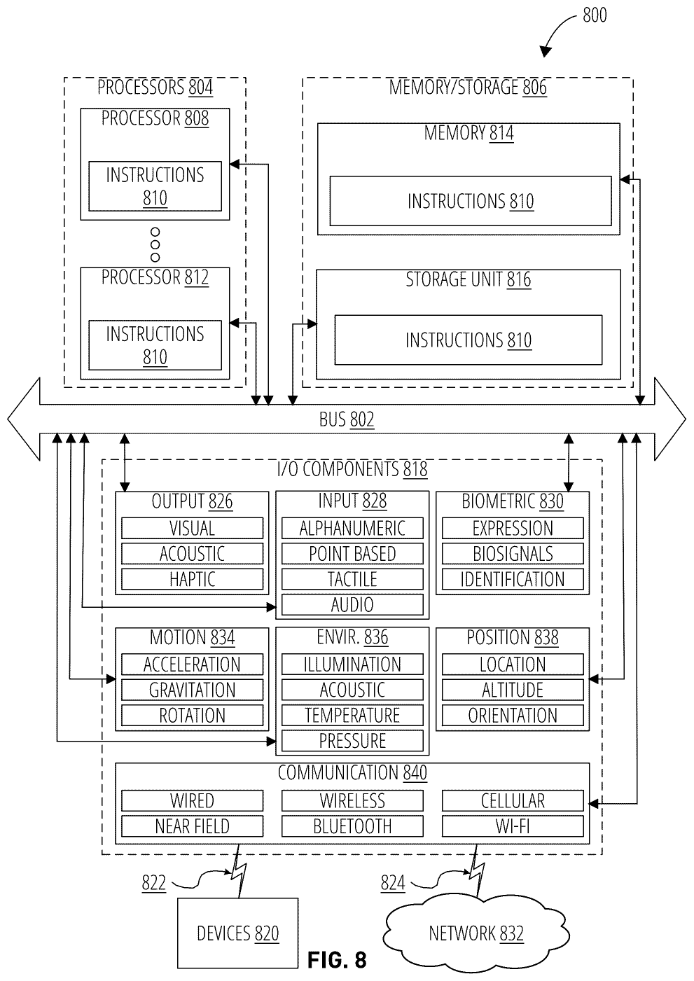

FIG. 7 is a block diagram illustrating an example of a software architecture 702 that may be installed on a machine, according to some examples. FIG. 7 is merely a non-limiting example of software architecture, and it will be appreciated that many other architectures may be implemented to facilitate the functionality described herein. The software architecture 702 may be executing on hardware such as a machine 800 of FIG. 8 that includes, among other things, processors 804, memory/storage 806, and I/O components 818. A representative hardware layer 734 is illustrated and can represent, for example, the machine of FIG. 8. The representative hardware layer 734 comprises one or more processing units 750 having associated executable instructions 736. The executable instructions 736 represent the executable instructions of the software architecture 702. The hardware layer 734 also includes memory or memory storage 752, which also have the executable instructions 738. The hardware layer 734 may also comprise other hardware 754, which represents any other hardware of the hardware layer 734 such as the other hardware illustrated as part of the machine 800.

In the example architecture of FIG. 7, the software architecture 702 may be conceptualized as a stack of layers, where each layer provides particular functionality. For example, the software architecture 702 may include layers such as an operating system 730 libraries 718, frameworks/middleware 716, applications 710, and a presentation layer 708. Operationally, the applications 710 or other components within the layers may invoke API calls through the software stack and receive a response, returned values, and so forth (illustrated as messages 756) in response to the API calls 758. The layers illustrated are representative in nature, and not all software architectures have all layers. For example, some mobile or special-purpose operating systems may not provide a frameworks/middleware 716 layer, while others may provide such a layer. Other software architectures may include additional or different layers.

The operating system 730 may manage hardware resources and provide common services. The operating system 730 may include, for example, a kernel 746, services 748, and drivers 732. The kernel 746 may act as an abstraction layer between the hardware and the other software layers. For example, the kernel 746 may be responsible for memory management, processor management (e.g., scheduling), component management, networking, security settings, and so on. The services 748 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 718 may provide a common infrastructure that may be utilized by the applications 710 and/or other components and/or layers. The libraries 718 (and/or libraries 722) typically provide functionality that allows other software modules to perform tasks in an easier fashion than by interfacing directly with the underlying operating system 730 functionality (e.g., kernel 746, services 748 or drivers 732). The libraries 718 and/or 722 may include system libraries 724 (e.g., C standard library) that may provide functions such as memory allocation functions, string manipulation functions, mathematic functions, and the like. In addition, the libraries 718 and/or 722 may include API libraries 726 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 718 and/or 722 may also include a wide variety of other libraries 744 to provide many other APIs to the applications 710 or applications 712 and other software components/modules.

The frameworks 714 (also sometimes referred to as middleware) may provide a higher-level common infrastructure that may be utilized by the applications 710 or other software components/modules. For example, the frameworks 714 may provide various graphical user interface functions, high-level resource management, high-level location services, and so forth. The frameworks 714 may provide a broad spectrum of other APIs that may be utilized by the applications 710 and/or other software components/modules, some of which may be specific to a particular operating system or platform.

The applications 710 include built-in applications 740 and/or third-party applications 742. Examples of representative built-in applications 740 may include, but are not limited to, a home application, a contacts application, a browser application, a book reader application, a location application, a media application, a messaging application, or a game application.

The third-party applications 742 may include any of the built-in applications 740 as well as a broad assortment of other applications. In a specific example, the third-party applications 742 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 742 may invoke the API calls 758 provided by the mobile operating system such as the operating system 730 to facilitate functionality described herein.

The applications 710 may utilize built-in operating system functions, libraries (e.g., system libraries 724, API libraries 726, and other libraries), or frameworks/middleware 716 to create user interfaces to interact with users of the system. Alternatively, or additionally, in some systems, interactions with a user may occur through a presentation layer, such as the presentation layer 708. In these systems, the application/module “logic” can be separated from the aspects of the application/module that interact with the user.

Some software architectures utilize virtual machines. In the example of FIG. 7, this is illustrated by a virtual machine 704. The virtual machine 704 creates a software environment where applications/modules can execute as if they were executing on a hardware machine. The virtual machine 704 is hosted by a host operating system (e.g., the operating system 730) and typically, although not always, has a virtual machine monitor 728, which manages the operation of the virtual machine 704 as well as the interface with the host operating system (e.g., the operating system 730). A software architecture executes within the virtual machine 704, such as an operating system 730, libraries 718, frameworks/middleware 716, applications 712, or a presentation layer 708. These layers of software architecture executing within the virtual machine 704 can be the same as corresponding layers previously described or may be different.

FIG. 8 is a block diagram illustrating components of a machine 800, according to some examples, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 810 (e.g., software, a program, an application, an applet, an app, or other executable code) for causing the machine 800 to perform any one or more of the methodologies discussed herein may be executed. As such, the instructions 810 may be used to implement modules or components described herein. The instructions 810 transform the general, non-programmed machine 800 into a particular machine 800 programmed to carry out the described and illustrated functions in the manner described. In alternative examples, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 808, sequentially or otherwise, that specify actions to be taken by machine 800. Further, while only a single machine 800 is illustrated, the term “machine” shall also be taken to include a collection of machines that individually or jointly execute the instructions 810 to perform any one or more of the methodologies discussed herein.

The machine 800 may include processors 804, memory/storage 806, and I/O components 818, which may be configured to communicate with each other such as via a bus 802. The memory/storage 806 may include a memory 814, such as a main memory, or other memory storage, and a storage unit 816, both accessible to the processors 804 such as via the bus 802. The storage unit 816 and memory 814 store the instructions 810 embodying any one or more of the methodologies or functions described herein. The instructions 810 may also reside, completely or partially, within the memory 814 within the storage unit 816, within at least one of the processors 804 (e.g., within the processor's cache memory), or any suitable combination thereof, during execution thereof by the machine 800. Accordingly, the memory 814, the storage unit 816, and the memory of processors 804 are examples of machine-readable media.

The I/O components 818 may include a wide variety of components to receive input, provide output, produce output, transmit information, exchange information, capture measurements, and so on. The specific I/O components 818 that are included in a particular machine 800 will depend on the type of machine. For example, portable machines such as mobile phones will likely include a touch input device or other such input mechanisms, while a headless server machine will likely not include such a touch input device. It will be appreciated that the I/O components 818 may include many other components that are not shown in FIG. 8. The I/O components 818 are grouped according to functionality merely for simplifying the following discussion and the grouping is in no way limiting. In various examples, the I/O components 818 may include output components 826 and input components 828. The output components 826 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input I/O components 828 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further examples, the I/O components 818 may include biometric components 830, motion components 834, environmental components 836, or position components 838 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 834 may include acceleration sensor components (e.g., accelerometer), gravitation sensor components, rotation sensor components (e.g., gyroscope), and so forth. The environment components 836 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 838 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 818 may include communication components 840 operable to couple the machine 800 to a network 832 or devices 820 via coupling 824 and coupling 822 respectively. For example, the communication components 840 may include a network interface component or other suitable device to interface with the network 832. In further examples, communication components 840 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 820 may be another machine or any of a wide variety of peripheral devices (e.g., a peripheral device coupled via a Universal Serial Bus (USB)).

Moreover, the communication components 840 may detect identifiers or include components operable to detect identifiers. For example, the communication components 840 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 840, such as, location via Internet Protocol (IP) geo-location, location via Wi-Fi® signal triangulation, location via detecting a NFC beacon signal that may indicate a particular location, and so forth.

### EXAMPLES

Example 1 is a system comprising: at least one processor; and at least one memory storing instructions that, when executed by the at least one processor, configure the system to perform operations comprising: responsive to receiving a query related to an industrial unit, generating a consultation prompt based on the query; retrieving, using a consultation agent, a response to the query; generating, based on the response, an evaluation prompt; retrieving, using an evaluation agent, an evaluation of the response; based on determining that the evaluation of the response is positive, generating a summarization prompt based on the response; retrieving, using a summarization agent, a response summary; and storing the response summary in a response set used to generate an answer comprising a repair plan, the answer to be transmitted to a scheduling system for scheduling repairs to the industrial unit.

In Example 2, the subject matter of Example 1 includes, wherein: the response set comprises a predetermined minimum number of response summaries, the response summaries generated by a plurality of summarization agents, the response summaries corresponding to responses generated by a plurality of consultation agents, the responses evaluated by a plurality of evaluation agents.

In Example 3, the subject matter of Example 2 includes, generating the answer further comprising: generating, based on the response summaries in the response set, an aggregation prompt; and retrieving, using an aggregation agent, the answer based on the response summaries.

In Example 4, the subject matter of Examples 2-3 includes, wherein: an agent of a plurality of agents is at least one of the consultation agent, the evaluation agent, the summarization agent, or an aggregation agent.

In Example 5, the subject matter of Examples 2-4 includes, wherein: each consultation agent of the plurality of consultation agents is bound to a bound evaluation agent of the plurality of evaluation agents, the respective consultation agent being different from the bound evaluation agent; and each consultation agent of the plurality of consultation agents is bound to a bound summarization agent of the plurality of summarization agents, the respective consultation agent being different from the bound summarization agent.

In Example 6, the subject matter of Examples 1-5 includes, wherein; generating the consultation prompt further comprises the use of a consultation prompt template; generating the evaluation prompt further comprises the use of an evaluation prompt template; and generating the summarization prompt further comprises the use of a summarization prompt template.

In Example 7, the subject matter of Examples 1-6 includes, wherein storing the response summary in the response set further comprises storing an entry corresponding to the consultation agent in the response set, the entry comprising one or more of an identifier of the consultation agent, a response status, the response, and the response summary.

In Example 8, the subject matter of Example 7 includes, wherein the response status is at least one of at least pending, received, responsive, non-responsive, or timed out.

In Example 9, the subject matter of Examples 3-8 includes, wherein retrieving the answer based on response summaries comprises: identifying one or more elements included in a predetermined proportion of the response summaries; and generating the answer to include the one or more identified elements.

In Example 10, the subject matter of Examples 1-9 includes, wherein retrieving the response to the query using the consultation agent comprises waiting for the response for a predetermined maximum time period.

Example 11 is at least one machine-readable medium including instructions that, when executed by processing circuitry, cause the processing circuitry to perform operations to implement of any of Examples 1-10.

Example 12 is an apparatus comprising means to implement of any of Examples 1-10.

Example 13 is a method (e.g., a computer-implemented method) to implement of any of Examples 1-10.

### GLOSSARY

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” (or “computer-readable medium”) in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se. The term “machine-readable medium” should be taken to refer to a non-transitory medium.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

### NOTES

Although example methods disclosed herein depict particular sequences of operations, the sequences may be altered without departing from the scope of the present disclosure. For example, some of the operations depicted may be performed in parallel or in a different sequence that does not materially affect the function of a respective method. In other examples, different components of an example device or system that implements the method may perform functions at substantially the same time or in a specific sequence.

What is claimed is:

1. A system comprising:
at least one processor; and
at least one memory storing instructions that, when executed by the at least one processor, configure the system to perform operations comprising:
responsive to receiving a query related to an industrial unit, generating a consultation prompt based on the query;
retrieving, using a consultation agent, a response to the query;
generating, based on the response, an evaluation prompt;
retrieving, using an evaluation agent, an evaluation of the response;
based on determining that the evaluation of the response is positive, generating a summarization prompt based on the response;
retrieving, using a summarization agent, a response summary; and
storing the response summary in a response set used to generate an answer comprising a repair plan, the answer to be transmitted to a scheduling system for scheduling repairs to the industrial unit.

2. The system of claim 1, wherein:
the response set comprises a predetermined minimum number of response summaries, the response summaries generated by a plurality of summarization agents, the response summaries corresponding to responses generated by a plurality of consultation agents, the responses evaluated by a plurality of evaluation agents.

3. The system of claim 2, generating the answer further comprising:
generating, based on the response summaries in the response set, an aggregation prompt; and
retrieving, using an aggregation agent, the answer based on the response summaries.

4. The system of claim 2, wherein:
an agent of a plurality of agents is at least one of the consultation agent, the evaluation agent, the summarization agent, or an aggregation agent.

5. The system of claim 2, wherein:
each consultation agent of the plurality of consultation agents is bound to a bound evaluation agent of the plurality of evaluation agents, the respective consultation agent being different from the bound evaluation agent; and
each consultation agent of the plurality of consultation agents is bound to a bound summarization agent of the plurality of summarization agents, the respective consultation agent being different from the bound summarization agent.

6. The system of claim 1, wherein:
generating the consultation prompt further comprises the use of a consultation prompt template;
generating the evaluation prompt further comprises the use of an evaluation prompt template; and
generating the summarization prompt further comprises the use of a summarization prompt template.

7. The system of claim 1, wherein storing the response summary in the response set further comprises storing an entry corresponding to the consultation agent in the response set, the entry comprising one or more of an identifier of the consultation agent, a response status, the response, and the response summary.

8. The system of claim 7, wherein the response status is at least one of at least pending, received, responsive, non-responsive, or timed out.

9. The system of claim 3, wherein retrieving the answer based on response summaries comprises:
identifying one or more elements included in a predetermined proportion of the response summaries; and
generating the answer to include the one or more identified elements.

10. The system of claim 1, wherein retrieving the response to the query using the consultation agent comprises waiting for the response for a predetermined maximum time period.

11. A computer-implemented method comprising:
responsive to receiving a query related to an industrial unit and using at least one processor, generating a consultation prompt based on the query;
retrieving, using a consultation agent, a response to the query;
generating, based on the response, an evaluation prompt;
retrieving, using an evaluation agent, an evaluation of the response;
based on determining that the evaluation of the response is positive, generating a summarization prompt based on the response;
retrieving, using a summarization agent, a response summary; and
storing the response summary in a response set used to generate an answer comprising a repair plan, the answer to be transmitted to a scheduling system for scheduling repairs to the industrial unit.

12. The method of claim 11, wherein the response set comprises a predetermined minimum number of response summaries, the response summaries generated by a plurality of summarization agents, the response summaries corresponding to responses generated by a plurality of consultation agents, the responses evaluated by a plurality of evaluation agents.

13. The method of claim 12, the method further comprising:
generating, based on the response summaries in the response set, an aggregation prompt; and
retrieving, using an aggregation agent, the answer based on the response summaries.

14. The method of claim 12, generating the answer further comprising:
an agent of a plurality of agents is at least one of the consultation agent, the evaluation agent, the summarization agent, or an aggregation agent.

15. The method of claim 12, wherein:
each consultation agent of the plurality of consultation agents is bound to a bound evaluation agent of the plurality of evaluation agents, the respective consultation agent being different from the bound evaluation agent; and
each consultation agent of the plurality of consultation agents is bound to a bound summarization agent of the plurality of summarization agents, the respective consultation agent being different from the bound summarization agent.

16. The method of claim 11, wherein:
generating the consultation prompt further comprises the use of a consultation prompt template;
generating the evaluation prompt further comprises the use of an evaluation prompt template; and
generating the summarization prompt further comprises the use of a summarization prompt template.

17. The method of claim 11, wherein storing the response summary in the response set further comprises storing an entry corresponding to the consultation agent in the response set, the entry comprising one or more of an identifier of the consultation agent, a response status, the response, and the response summary.

18. The method of claim 17, wherein the response status is at least one of at least pending, received, responsive, non-responsive, or timed out.

19. The method of claim 13, wherein retrieving the answer based on response summaries comprises:
identifying one or more elements included in a predetermined proportion of the response summaries; and
generating the answer to include the one or more identified elements.

20. A non-transitory computer-readable storage medium, the computer-readable storage medium including instructions that when executed by a computer, cause the computer to:
responsive to receiving a query related to an industrial unit, generate a consultation prompt based on the query;
retrieve, using a consultation agent, a response to the query;
generate, based on the response, an evaluation prompt;
retrieve, using an evaluation agent, an evaluation of the response;
responsive to determining that the evaluation of the response is positive, generate a summarization prompt based on the response;
retrieve, using a summarization agent, a response summary; and
store the response summary in a response set used to generate an answer comprising a repair plan, the answer to be transmitted to a scheduling system for scheduling repairs to the industrial unit.
